(19) United States
(12) Patent Application Publication
(10) Pub. No.: US 2002/0135494 A1
(43) Pub. Date: Sep. 26, 2002

(54) Telemetry system

(76) Inventor: Hideko Nanjo, Nishitama-gun (JP)

Correspondence Address: PILLSBURY WINTHROP, LLP, P.O. BOX 10500, MCLEAN, VA, 22102, US

(21) Appl. No.: 10/076,372

(22) Filed: Feb. 19, 2002

(30) Foreign Application Priority Data
Mar. 22, 2001 (JP) 2001-082696

(51) Int. Cl. H04Q 9/00; G08C 19/22

(52) U.S. Cl. 340/870.07

(57) ABSTRACT

The information sent from a center, the information a telemetry terminal itself holds, and a control apparatus with a display unit holds are displayed on the display unit provided in the control apparatus.

### CROSS-REFERENCE TO RELATED APPLICATIONS

This application is based upon and claims the benefit of priority from the prior Japanese Patent Application No. 2001-082696, filed Mar. 22, 2001, the entire contents of which are incorporated herein by reference.

### BACKGROUND OF THE INVENTION

1. Field of the Invention

This invention relates to a telemetry system.

2. Description of the Related Art

One known telemetry system is such that it measures the data from a remote data source, transmits the measured data to the target point, and displays or records the data there. Recently, an application has been developed which applies the telemetry system to a vending machine and sends the state of stock and accumulated data on the sales performance via a telemetry terminal to the center by wireless. In such an application, a telemetry terminal is housed inside the front door of the vending machine and an antenna is provided in, for example, the sample goods section on the front door side.

Jpn. Pat. Appln. KOKAI Publication No. 9-117520 (U.S. Ser. No. 08/510369) has disclosed a diagnostic system and method for use with a medical device implanted in a patient. Telemetry means receives the medical data from the medical device. The medical data includes physiological data about the medical conditions of the patient and parameter data regarding the operating characteristics of the medical device. Long-time storage means stores a data file of the patient's case history including the medical data received via the telemetry means from the medical device. Control means integrates the medical data received via the telemetry means from the medical device during the current transmission into the data file of the patient's case history stored in the long-time storage means.

This conventional type of telemetry terminal, however, might not have a display unit. Since the telemetry terminal itself was housed inside the front door, even if it had a display unit, it would be difficult to understand the state of the machine. This caused the problem of making installation work difficult or impairing the efficiency of maintenance work because the terminal remained inside. For instance, even if a signal strength were displayed on the telemetry terminal, it would be difficult to install an antenna, while checking the displayed signal strength. In a case where the telemetry terminal has a display unit, when the technician installs an antenna, while watching the display unit, he or she installs the antenna in the sample on the front door side, with the front door of the vending machine open. In practical use, however, the vending machine is used with the front door closed. As a result, there is a possibility that the antenna will be installed in a position different from where it should be in place, leading to a poor performance.

Furthermore, it is difficult to confirm the setting values (e.g., the setting of data transmission speed) of the telemetry terminal, the test items being tested, and the end of the test in checking the test and others after the installation of the antenna.

In addition, even if the telemetry terminal malfunctioned with an error indication of the occurrence of a data transmission error or the like, time would be spent wastefully before the indication was confirmed.

### BRIEF SUMMARY OF THE INVENTION

The object of the present invention is to provide a telemetry system which is capable of, when an apparatus provided with a telemetry terminal has a display unit, such as an LED or LCD, displaying not only information on the display unit but also information from a center on the display unit of the apparatus provided with the telemetry terminal, and which is further capable of displaying information about the apparatus provided with the telemetry terminal on the display unit of the apparatus.

The foregoing object is accomplished by a telemetry system characterized by comprising: a telemetry terminal; a display unit provided in an apparatus equipped with the telemetry terminal; and a control section which is provided in the apparatus equipped with the telemetry terminal and which is connected to the telemetry terminal and the display unit and displays information about the telemetry terminal on the display unit.

With the above configuration, use of the display unit of the installed apparatus, not the telemetry terminal itself, makes it easy to see the signal strength in installing an antenna, enabling work to be done in a manner close to practical use. This improves the efficiency upon installation and maintenance.

According to the present invention, the telemetry system is characterized by further comprising a center which exchanges data with the telemetry terminal, wherein the control section, at the request of the center, displays on the display unit information about the telemetry system and the information transmitted from the center.

With the above configuration, the request of the center acts as a trigger and causes advertisements or information sent from the center, including weather forecasts and other added information, to be displayed on the display unit of the apparatus. In addition, the data the apparatus itself manages, such as accumulation data about the contents of the apparatus (e.g., stock or the consumption of electricity or gas) or ambient temperature when the temperature is being measured, can be displayed.

With this invention, an instruction is given to the control section of the telemetry terminal apparatus, thereby causing the display unit of the apparatus to display the signal strength, and information about the inside of the telemetry terminal. This enables the technician to work, while viewing the display unit of the apparatus with ease from the outside, and further to conduct checks in a manner close to practical use.

Furthermore, the setting values of the telemetry terminal, the items being tested, and the end of the test are displayed on the display unit of the apparatus provided with the terminal, which enables checks to be made easily from the outside.

When an error has occurred, the telemetry terminal instructs the control section of the apparatus to display information that an error has occurred, thereby causing the display unit of the apparatus provided with the terminal to display the information. This enables the occurrence of an error to be confirmed easily from the outside.

In normal operation, at the request of the center, the information sent from the center can be displayed on the display unit of the apparatus with the telemetry s terminal by way of the terminal. Advertisements being displayed can be changed at regular time intervals. In addition, weather forecasts can be displayed at fixed time intervals.

Furthermore, in normal operation, at the request of the center, the information the apparatus with the telemetry terminal holds (e.g., in the case of a vending machine, inventory information, accumulated data on sales performance, or best-seller information) can be displayed on the display unit of the apparatus. In inventory management, the weekly best-seller ranking or the like may be displayed. In managing the consumption of electricity or gas, the daily consumption or the like may be displayed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows an example of the configuration of a telemetry system according to the present invention;

FIG. 2 is a block diagram showing a detailed configuration of the telemetry system shown in FIG. 1;

FIG. 3 is a detailed block diagram of the telemetry terminal shown in FIG. 2; and

FIG. 4 is a flowchart to help explain the process of displaying information on the display unit.

### DETAILED DESCRIPTION OF THE INVENTION

Hereinafter, referring to the accompanying drawings, an embodiment of the present invention will be explained.

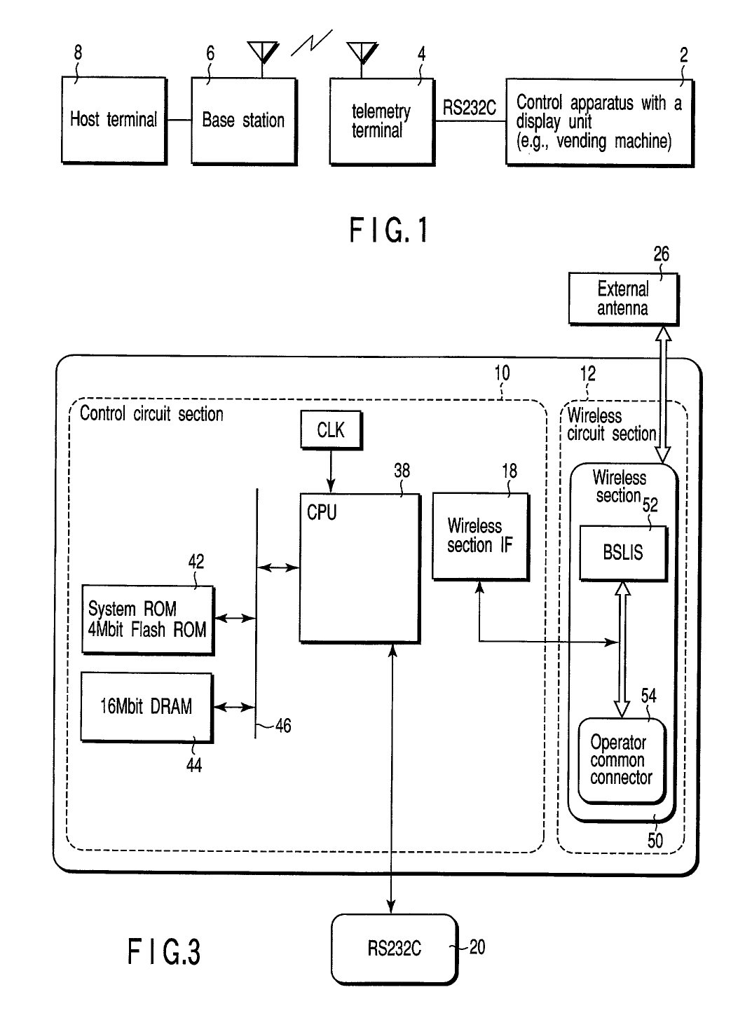

FIG. 1 is a system block diagram of an embodiment of a telemetry system according to the present invention. A control apparatus 2 with a display unit, such as a vending machine, an electricity meter, or a gas meter, is connected via an RS232C to a telemetry terminal 4. The telemetry terminal 4 is connected to a base station 6 by wireless. A host terminal 8 is connected to the base station 6. Various information is exchanged between the host terminal 8 and the control apparatus 2 with a display unit via the base station 6 and telemetry terminal 4. The host terminal 8 transmits, for instance, information on advertisements for merchandise or on weather forecasts. The control apparatus 2 with a display unit transmits, for instance, best-seller ranking information about merchandise in the vending machine or daily consumption of electricity or gas.

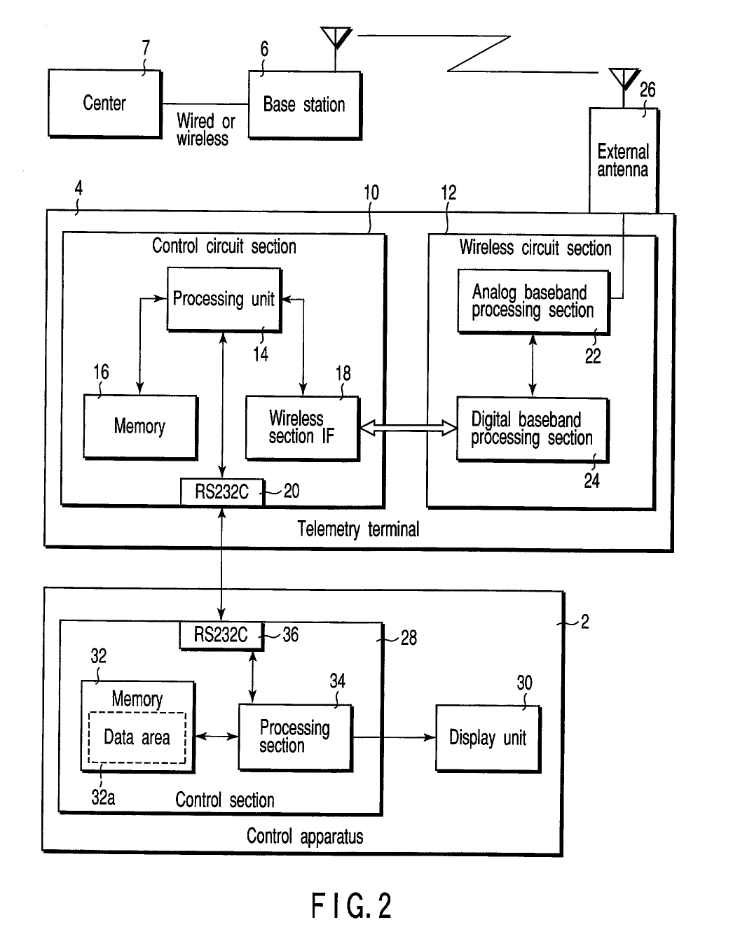

FIG. 2 is a detailed block diagram of the telemetry system shown in FIG. 1. The telemetry terminal 4 has a control circuit section 10 and a wireless circuit section 12. The control circuit section 10 has a processing unit 14, a memory 16, a wireless section I/F 18, and an RS232C interface 20. The wireless circuit section 12 has an analog baseband processing section 22 and a digital baseband processing section 24. The control circuit section 10 is connected to the wireless circuit section 12 via the wireless section I/F 18 and digital baseband processing section 24. The analog baseband processing section 22 is connected to an external antenna 26. The telemetry terminal 4 is connected to the base station 6 via the external antenna 26. The base station 6 is connected to a center 7 by wireless or by wire. The processing unit 14 may be composed of, for example, a CPU.

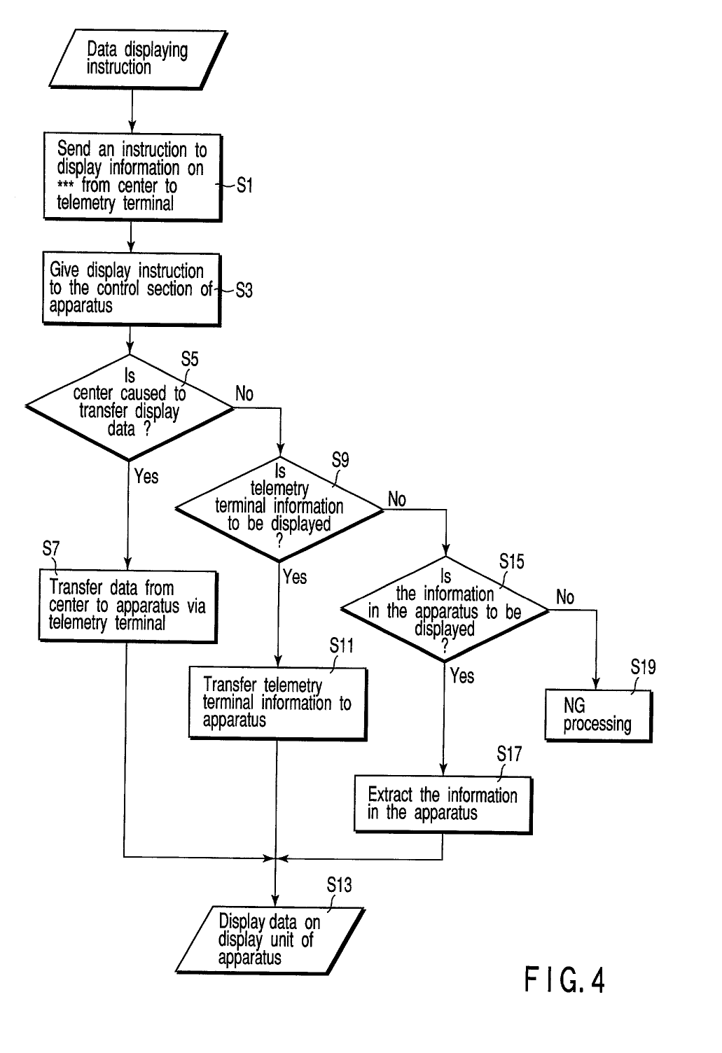

The control apparatus 2 with a display unit has a control section 38 and a display unit 30. The control section 28 has a memory 32, a processing section 34, and an RS232C interface 36. The memory 32 has a data h area 32a. The control section 28 may be composed of, for example, a personal computer or its equivalent. The control apparatus 2 with the display unit is connected to the telemetry terminal 4 via the RS232C interface 36 and RS232C interface 20. The processing section 34 may be composed of, for example, a CPU. The memory 32 stores a program for the flowchart of FIG. 4.

The control section 28 displays the following pieces of information on the display unit 30: the signal strength at the external antenna 26, information about the internal setting of the telemetry terminal 4, information about errors in the communication between the control apparatus 2 and telemetry terminal 4, and information about errors in the communication between the telemetry terminal 4 and base station 6. The information about the internal setting of the telemetry terminal 4 includes information about the data transmission speed setting of the telemetry terminal 4, the test items being tested, information about the end of the test, and information about data transmission errors in the telemetry terminal 4.

The control section 28 also displays the information the control apparatus 2 itself holds on the display unit 30. The information the control apparatus 2 itself holds includes inventory information, accumulated data on sales performance, daily consumption of electricity or gas, and best-seller ranking information in inventory management.

The display unit 30 is composed of, for example an LED or an LCD. When the control apparatus 2 is, for example, a vending machine, the display unit is installed on the outside of the front door.

FIG. 3 is a detailed block diagram of the control circuit section 10 and wireless circuit section 12 shown in FIG. 2. In FIG. 3, the control circuit section 10 has a CPU 38, a system ROM 42 and a DRAM 44. The CPU 38, system ROM 42, and DRAM 44 are connected via a system bus 46. The CPU 38 is also connected to the wireless section I/F 18. The wireless section I/F 18 is connected to the wireless circuit section 12.

The wireless circuit section 12 has a wireless section 50. The wireless section 50 has a baseband LSI (BBLSI) 52 and a common connector 54.

In the telemetry system of the present invention configured as described above, for example, when the control apparatus 2 with the display unit is a vending machine, the technician can install the external antenna 26, while viewing the display unit 3 provided on the front door side of the vending machine 2. Specifically, the signal strength of the external antenna 26 is supplied to the CPU 38 via the baseband LSI 52 of the wireless section 50 and the wireless section I/F 18. The CPU 38 outputs this information via the RS232C interface 20 and RS232C interface 36 to the control section 28 of the control apparatus 2 with the display unit. The processing section 34 of the control section 28 displays on the display unit 30 information about the signal strength received from the telemetry terminal 10. This enables the technician to work, while viewing the display unit 30 with ease from the outside, and further, to check the state of the apparatus in a manner close to practical use.

Furthermore, the telemetry terminal 12 transmits the setting values (e.g., data transmission speed setting) of the telemetry terminal stored in the memory 16 during operation trials after installation of the antenna, the test items being tested, and the end of the test via the RS232C interfaces 20 and 36 to the control apparatus 2 with the display unit. The processing section 34 of the control section 28 on the control apparatus 2 side displays on the display unit 30 this information transmitted from the telemetry terminal 4.

If a data transmission error has occurred between the telemetry terminal 4 and the center 7, or if a data transmission error has occurred between the telemetry terminal 4 and the control apparatus 2, the processing unit 14 of the control circuit section 10 in the telemetry terminal 4 transmits data transmission error information to the processing section 34 of the control apparatus 2 via the RS232C interfaces 20, 36. The processing section 34 displays on the display unit 30 the data transmission error information transmitted from the telemetry terminal 4. The data transmission error information is displayed in the form of a data transmission error code when the display unit 30 is, for example, an LED, and in the form of an error message when the display unit 30 is, easily for example, an LCD. This makes it possible to easily confirm, from the outside the occurrence of an error.

While the control apparatus 2 with the display unit is in normal operation, the center 7 outputs a request to display information on the display unit 30 of the control apparatus 2. The request is supplied to the base station 6, external antenna 26, and the control circuit section 10 of the telemetry terminal 4. In response to the request, the telemetry terminal 4 receives the request and the display information added to the request and transmits them via the RS232C interfaces 20, 36 to the control apparatus 2 side under the control of the processing unit 14. The processing section 34 of the control apparatus 2 receives the display information and displays it on the display unit 30. The information includes, for example, information on weather forecasts or on advertisements for merchandise.

The center 7 can make a request to display on the display unit 30 the information the control apparatus 2 with the display unit holds. This request is transmitted to the processing section 34 of the control apparatus 2 via the base station 6, external antenna 26, and telemetry terminal 4. In response to the request, the processing section 34 displays on the display unit 30 the information stored in the data area 32a of the memory 32. Taking a vending machine as an example, the information includes inventory information, accumulated data on sales performance, best-seller information (e.g., daily, weekly, and monthly best-seller ranking information). In the case of electric meters or gas meters, the information includes, for example, daily consumption of electricity or gas.

FIG. 4 is a flowchart to help explain the process of displaying information on the display unit 30. At step S1 of FIG. 4, the center 7 transmits an information display instruction to the telemetry terminal 4. Next, at step S3, the telemetry terminal 4 outputs the display instruction to the control section 28 of the control apparatus 2 via the RS232C interfaces 20, 36. Then, at step S5, it is judged whether to cause the center 7 to transfer the display data or not. If at step S5, it has been judged that the center 7 is caused to transfer the display data, the information from the center 7 is, at step S7, transmitted to the control apparatus 2 via the base station 6, external antenna 26, and telemetry terminal 4.

On the other hand, if at step S5, it has been judged that the center 7 is not caused to transfer the display data, it is judged at step S9 whether to display the information from the telemetry terminal 4. If at step S9, it has been judged that the information from the telemetry terminal 4 is to be displayed, the information stored in the memory 16 of the telemetry terminal 4 is, at step S11, transferred to the control apparatus via the RS232C interfaces 20, 36.

On the other hand, if at step S9, it has been judged that the information from the telemetry terminal 4 is not to be displayed, it is judged at step S15 whether to display the information the control apparatus 2 itself holds. If at step S15, it has been judged that the information the control apparatus 2 itself holds is to be displayed, the information stored in the data area 32a of the memory 32 is extracted at step S17. Then, at step S13, the information from the center 7 at step S7, the information from the telemetry terminal 4 at step S11, and the information extracted at step S17 are displayed on the display unit 30. If at step S15, if it has been judged that the information the control apparatus holds is not to be displayed, an abort process is carried out at step S19.

While in the above-described embodiment, the telemetry terminal and the control apparatus with the display unit are connected via the RS232C, the present invention is not limited to the embodiment. For instance, they may be connected to each other via a USB (Universal Serial Bus), a parallel interface, or a serial interface.

Additional advantages and modifications will readily occur to those skilled in the art. Therefore, the invention in its broader aspect is not limited to the specific details and representative embodiments shown and described herein. Accordingly, various modifications may be made without departing from the spirit scope of the general inventive concept as defined by the appended claims and their equivalents.

What is claimed is:

1. A telemetry system comprising:
a telemetry terminal;
a display unit provided in an apparatus equipped with said telemetry terminal; and
a control section which is provided in the apparatus equipped with said telemetry terminal, said control section being connected to said telemetry terminal and said display unit and displays an information on said display unit.

2. The telemetry system according to claim 1, wherein said telemetry terminal further comprises an antenna; and
the information that said control section causes said display unit to display includes one of the signal strength at said antenna, information about the internal setting of said telemetry terminal, information about errors in the communication between said apparatus and said telemetry terminal, and information about errors in the communication using said antenna.

3. The telemetry system according to claim 2, wherein the information about internal setting of said telemetry terminal that said control section causes said display unit to display includes one of information about data transmission speed of wireless communication using said antenna, information about the test items being tested, and information about the end of the test.

4. The telemetry system according to claim 1, wherein said telemetry terminal further comprises an antenna and receives information transmitted from a center; and
said control section causes said display unit to display the information received by said telemetry terminal through said antenna.

5. The telemetry system according to claim 4, wherein the information received by said telemetry terminal from the center includes one of information about advertisements for merchandise and information about weather forecasts.

6. The telemetry system according to claim 1, wherein the information that said control section causes said display unit to display is information held by the apparatus.

7. The telemetry system according to claim 6, wherein the information that said control section causes to said display unit to display includes one of inventory information, accumulated data on sales performance, and information of daily consumption of electricity.

8. The telemetry system according to claim 5, wherein said control section causes said display unit to display the information in accordance with a request from the center.
